(19) United States
(12) Patent Application Publication
(10) Pub. No.: US 2019/0019189 A1
(43) Pub. Date: Jan. 17, 2019

(54) PAYMENT AUTHENTICATION

(71) Applicant: HEWLETT-PACKARD DEVELOPMENT COMPANY, L.P., HOUSTON, TX (US)

(72) Inventor: AARON SANDERS, HOUSTON, TX (US)

(21) Appl. No.: 16/067,738

(22) PCT Filed: Mar. 28, 2016
(86) PCT No.: PCT/US2016/024418

§ 371 Date: Jul. 2, 2018

(51) Int. Cl. G06Q 20/40; G06F 3/01

(52) U.S. Cl. CPC G06Q 20/409; G06F 3/011; G06F 3/017; G06Q 20/401

(57) ABSTRACT

Example implementations relate to payment authorization. An example payment authorization may include receiving an image of a custom gesture recorded via a camera coupled to a payment device, receiving payment information via the payment device, and decoding the custom image and the payment information. Payment authorization may also include encrypting the custom image and the payment information, sending the encrypted custom image and the encrypted payment information to a secure server, and decrypting, via the secure server, the encrypted custom image and the encrypted payment information. Payment authorization may further include comparing the custom image to a database of custom images, comparing the payment information to a database of known payment information, and sending an encrypted payment authentication response to the device.

### BACKGROUND

A payment device, also known as a payment terminal, point of sale terminal, credit card terminal, or EFTPOS terminal is a device which interfaces with payment cards to make electronic funds transfers. A payment device allows a merchant to insert, swipe, or manually enter the required credit card information, to transmit this data to the merchant service provider for authorization and to transfer funds to the merchant.

### BRIEF DESCRIPTION OF THE DRAWINGS

FIG. 1 illustrates a diagram of a system including a payment device and a computing system including a processing resource, a memory resource, and a number of modules according to an example;

FIG. 2 illustrates a diagram of a method for payment authentication according to an example;

FIG. 3 illustrates a diagram of a method for payment authentication according to an example;

FIG. 4 illustrates a diagram of a method for payment authentication according to an example; and

FIG. 5 illustrates a diagram of an example computing system including a processing resource, a memory resource, and a number of modules according to an example.

### DETAILED DESCRIPTION

Credit card, debit card, and other payment methods use chips and/or an associated personal identification number (PIN) or signature for payment authentication. As used herein, payment authentication includes securing identity using a multi-factor authentication at a transaction level. For example, a two-factor authentication may include a card and/or a chip plus a PIN, and a three-factor authentication may include a card plus a PIN plus a fingerprint. A chip card is a smart card that stores their data on integrated circuits rather than magnetic stripes (though some chip cards have both). A user's payment information is authenticated only after each factor of the multi-factor authentication is verified.

Some approaches to payment authentication include the use of payment devices with integrated PIN pads, which may add cost and size to a device. Additionally, using an integrated PIN pad may not be secure, in that the PIN number may be captured with ease by a skimmer or observer.

In contrast, payment authentication according to the present disclosure may include capturing a gesture via a camera on a payment device to be used as authentication (e.g., used as a PIN). For instance, examples of the present disclosure allow a consumer to use a hand gesture that is captured by a camera, which may be used in place of a manually entered PIN number.

Payment authentication according to the present disclosure may allow for a smaller, more compact, and more mobile payment device. This also may allow for the elimination of a residual impression. This is in contrast to approaches using physical PIN pads, which may allow for residual that may be obtained from finger prints or heat signatures on the PIN pad keys, leading to potentially stolen information.

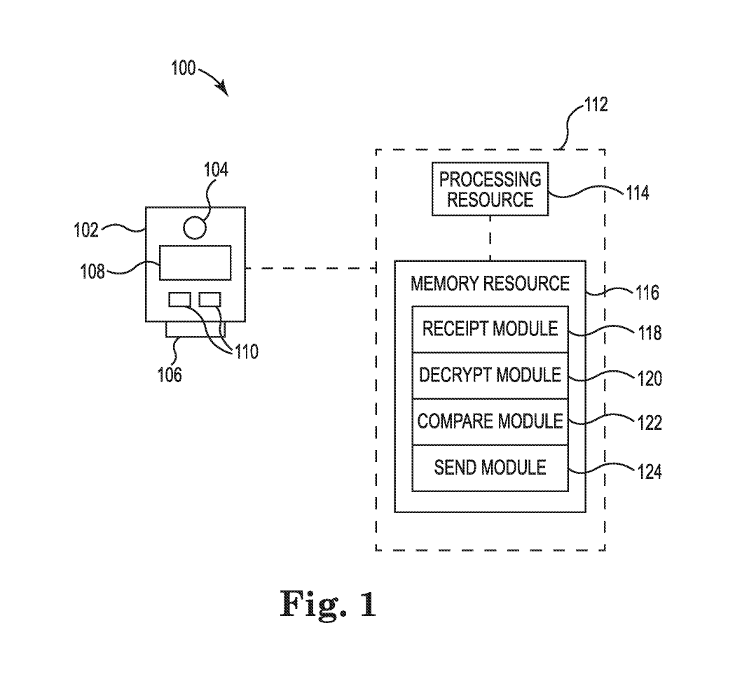

FIG. 1 illustrates a diagram of a system 100 including a payment device 102 and a computing system 112 including a processing resource 114, a memory resource 116, and a number of modules 118, 120, 122, 124 according to an example. Payment device 102 may include camera 104 and payment interface 106. Payment interface 106 may include an interface to receive a payment type including a credit card, debit card, smartphone, etc. Payment interface 106 may be a card swiper, a chip card receiver, a phone payment pad, and/or other payment reception interfaces.

Payment device 102 may be Payment Card Industry Data Security Standard (PCI DSS) compliant. For instance, system 100 including payment device 102 and computing system 112 may be compliant such that the use of the system 100 meets the 6 groups of requirements of PCI DSS, including the following: building and maintaining a secure network, protecting cardholder data, maintaining a vulnerability management program, implementing strong access control measures, regularly monitoring and testing networks, and maintaining an information securing policy.

Camera 104 may be a 2-dimensional, 3-dimension, or other type of camera and may collect an image of a gesture. The gesture may be recognized via image processing by a chipset application program interlace (API), and may be saved for use in future comparison. The gesture may be used in payment authentication (e.g., authenticating the user) in place of, or in addition to, a PIN. In some instance, a PIN may be encoded in the gesture (e.g., sign language gesture), as will be discussed further herein.

The gesture may be sign language gesture, a generic gesture, and/or a custom gesture. For example, in lieu of entering a PIN into PIN pad, a user may sign the PIN in front of the camera, and the camera may capture that gesture. A generic gesture may be a gesture such as a thumbs up or a peace sign. A custom gesture may be a gesture created by the user and may be unique to that user. For instance, a user may choose to make four different gestures in a row to represent a PIN. These gestures may be previously recorded and stored for the verification process. For instance, a user may go to a bank and record the custom gesture or record the custom gesture over a secure Internet connection using a web cam. Other methods of securely recording the gesture may be used.

As noted above, a sign language gesture may be used as a means to capture a PIN. For example, payment device 102 may prompt a user via display 108 to enter a PIN. The user may use sign language or raise the appropriate number of fingers for each number in his or her PIN. Once all the numbers of the PIN are entered and captured by camera 104, the PIN is collected by device 102 and may be used to compare as if the PIN was entered on a PIN pad.

The image of the gesture may be a moving image and/or a still image. For instance, a generic gesture image may be a still image of a thumbs up, while a custom gesture image may be a moving image (e.g., video) of a string of gestures.

Payment interface 106 may collect payment information before, after, or while the user is providing his or her gesture. For instance, a user may insert a credit card into payment interface 106, and follow that with his or her gesture. These may be done in reverse order or simultaneously in other examples.

In some instances, payment device 102 may also include a display 108 and/or input buttons 110. Display 108 and/or input buttons 110 may be small, such that they take up less room than a PIN pad. Display 108 may show display text to a user. For instance an approved or denied response may be displayed on display 108. A prompted to provide a gesture may be displayed. Other payment information and/or gesture information or prompts may also be displayed on display 108. Input buttons 110 may provide a way for the user to interact with payment device 102. For instance, input buttons 110 may include a cancel button and an ok button. These buttons may be used by a user to answer questions or prompts on display 108. For instance, a user may be prompted to choose credit or debit, and input buttons 110 may be used to answer this prompt. Payment device 102 may include more or fewer elements than illustrated in FIG. 1 in some examples.

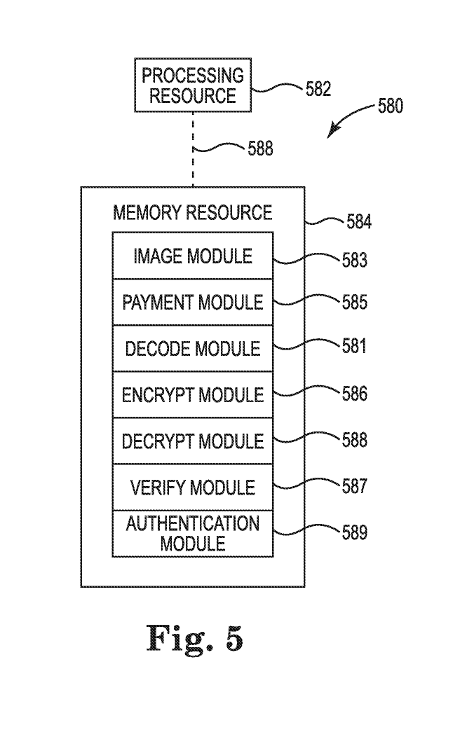

Computing system 112 may be coupled to payment device 102 and may include a processing resource 114, a memory resource 116, and a number of modules 116, 118, 120, 122, 124 according to an example, Computing system 112 may utilize instructions (e.g., software and/or firmware) hardware, and/or logic to perform a number of functions including those described herein, Computing system 112 may be a combination of hardware and program instructions configured to share information. The hardware, for example, may include a processing resource 114 and/or a memory resource 116 (e.g., computer-readable medium (CRM), machine-readable medium (MRM), database, etc.). Computing system 112 may be similar to and include the same or similar elements as computing system 580, which is described in greater detail with respect to FIG. 5. Computing system 112 may be a local computer or a remote server, among other computing systems, for example.

A module and/or modules 116, 118, 120, 122, 124 may include machine-readable instructions (MRI) that when executed by the processing resource 112 may perform a number of functions including those described herein. For instance, receipt module 118 may include instructions that when executed by the processing resource 114 may cause a computing system to receive, from payment device 102, encrypted payment information and data associated with the gesture. For instance, computing system 112 may receive from payment device 102 encrypted payment information received from a user who inserted a credit card into payment interface 106. Received data associated with the gesture may include image data that has been decoded into code.

Decrypt module 120 may include instructions that when executed by the processing resource 114 may cause a computing system to decrypt the encrypted payment and gesture data. The encrypted payment information and gesture data may be decrypted, for instance by a server, to allow for comparisons and verification of the payment information and gesture data.

Compare module 122 may include instructions that when executed by the processing resource 114 may cause a computing system to compare the decrypted payment information and the decrypted gesture data to verified payment and gesture data. By doing this comparison, payment may be authenticated for the particular transaction.

Send module 124 may include instructions that when executed by the processing resource 114 may cause a computing system to send an encrypted payment authentication response to the payment device 102 based on the comparison. For example, if both the payment information and the gesture data are verified, an “approved” response may be sent to payment device 102. If neither is verified, a “denied” response may be sent to payment device 102. If one or the other is not verified, a “denied” or other response may be sent to payment device 102. For instance, an “invalid PIN” response may be sent, among other responses. The response may be displayed via display 108.

In some examples, memory resource 116 may include a verification module including instructions that when executed by processing resource 114 may cause a computing system to verify the decrypted payment information and the decrypted gesture data based on the comparison. The decrypted payment information and the decrypted gesture data may be compared to databases of known information. Matches in the comparison may result in a verification of the payment information and/or the decrypted gesture data, indicating they are valid.

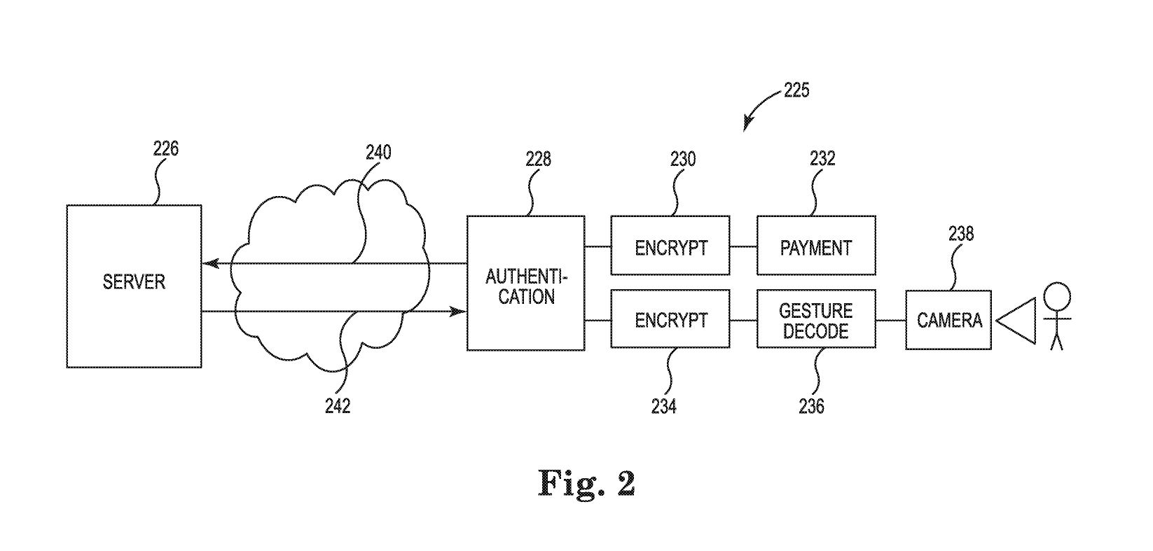

FIG. 2 illustrates a diagram 225 of a method for payment authentication according to an example. At 238, a gesture is captured by a camera on a payment device. The gesture, in this example, may be a PIN spoken in sign language or a PIN given by holding a number of fingers in front of the camera corresponding to numbers of the PIN in this example. The gesture may be recognized using image processing at the payment device, or at a separate server.

At 232, payment information is received at the payment device. This may be via a credit card, debit card, phone payment, etc. received at a payment interface. The payment information is encrypted at 230. The payment information is encrypted, so that it may be passed over an operating system (OS) to deny availability of the payment information content to the OS. This allows for compliance with PCI DSS.

At 236, the gesture is decoded into data, and at 234 the data is encrypted. Similar to the payment information, the data is encrypted, so that it may be passed over an operating system (OS) to deny availability of the payment information content to the OS while complying with PCI DSS.

At 228, a request for payment authentication is made, and the encrypted payment information and the encrypted gesture data are sent to a secure server at 240. The secure server may include or be part of a payment gateway, payment provider, bank server, etc. capable of verifying payment information and gesture data including PIN data.

At 226, the secure server decrypts the encrypted payment information and the encrypted gesture data. The decrypted payment information is compared to known payment information for verification, and the decrypted gesture data is compared to known gesture data for verification. Based on the comparison, the secure server encrypts a response (e.g., approved, denied, other, etc.) and sends it back to the payment device at 242.

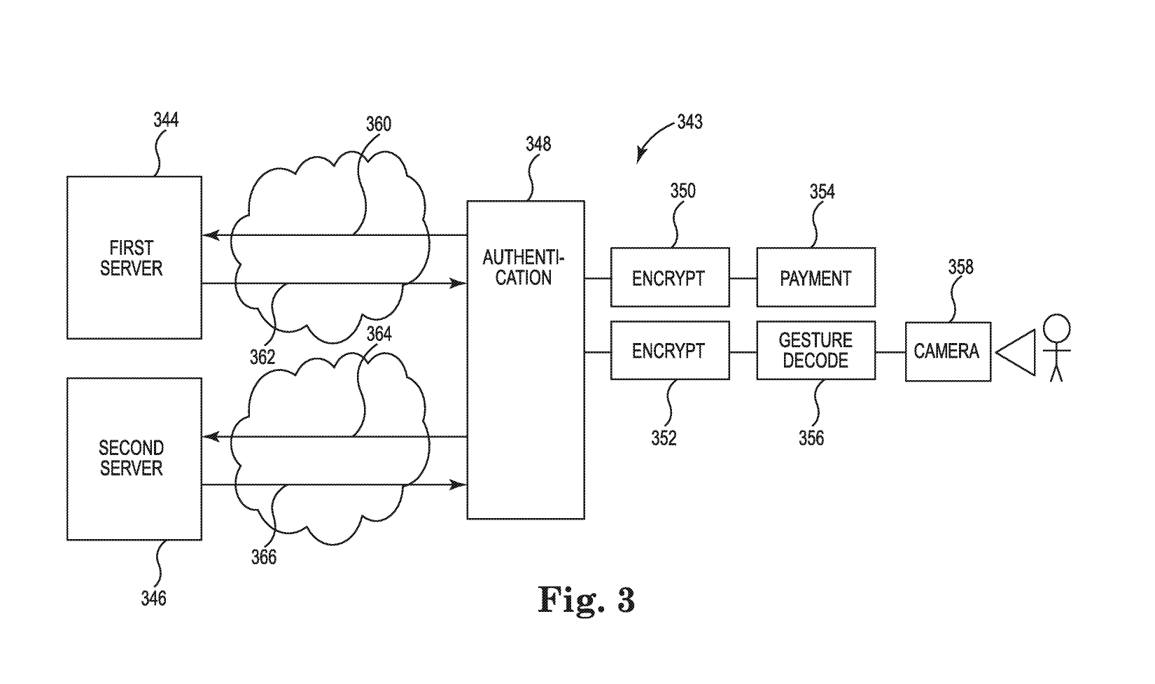

FIG. 3 illustrates a diagram 343 of a method for payment authentication according to an example. At 358, an image of a gesture is captured by a camera on a payment device. In this example, the gesture may be a custom gesture. For instance, a user may have created a personalized, unique, custom gesture to use in place of, or in addition to a PIN. The custom gesture may have been recorded by the user at a secure location, such as a bank, an automated teller machine (ATM), or over a secure home network connection. This custom gesture may be stored in a database for future comparisons.

At 354, payment information is received at a payment interface of the payment device. For instance, a user may attempt to pay for a transaction using a payment method (e.g., credit card, debit card, smartphone, etc.). The image, whether still or moving, is decoded at 356 to data, and at 352, the image data is encrypted. The payment information is encrypted at 350.

At 348, a request for payment authentication is made, and the encrypted payment information is sent to a first secure server at 360, and the encrypted gesture data is sent to a second, different secure server at 364. The first secure server may include, for instance, a payment gateway, payment provider, or other payment authorization application service provider. The first secure server may facilitate the transfer of information between the payment device and a Front End Processor or acquiring bank, for instance. The second secure server may be a bank server that has PIN and/or gesture data available to verify the user's gesture data.

At 344, the first secure server decrypts the encrypted payment information. The decrypted payment information is compared to known payment information for verification, and based on the comparison, the first secure server encrypts a response (e.g., approved, denied, other, etc.) and sends it back to the payment device at 362. For instance, a match in the comparison may result in an approved response, while a mismatch may result in a denied response. Other responses may be given, in some examples. The responses may be display via a display on the payment device.

At 346, the second secure server decrypts the encrypted image data, and the decrypted gesture data is compared to known gesture data for verification. Based on the comparison, the second secure server encrypts a response (e.g., approved, denied, other, etc.) and sends it back to the payment device at 366. For instance, a match in the comparison may result in an approved response, while a mismatch may result in a denied response. Other responses may be given, in some examples. The responses may be display via a display on the payment device.

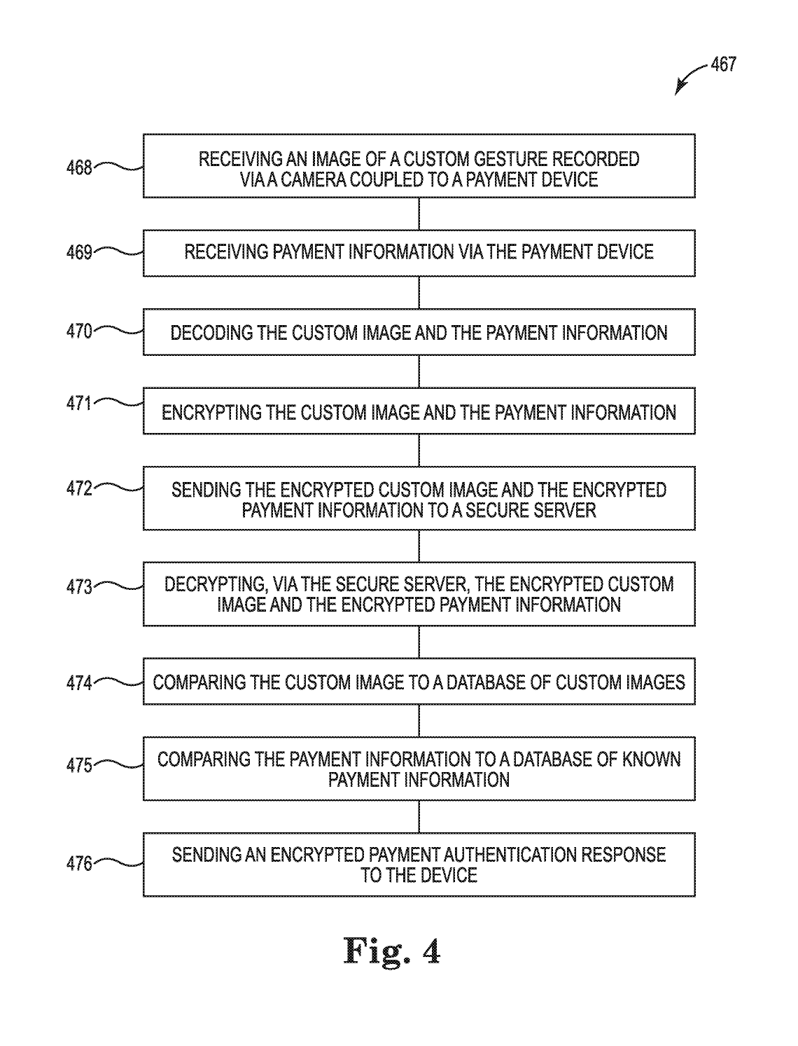

FIG. 4 illustrates a diagram of a method 467 for payment authentication according to an example. At 468, method 467 may include receiving an image of a custom gesture recorded via a camera coupled to a payment device. The custom gesture may be created by the user, recorded over a secure connection, and saved by a bank or other provider in a database for future comparisons.

At 469, method 467 may include receiving payment information via the payment device. The payment information may come from a user inserting a credit card or other payment method into the payment device. Method 467, at 470, may include decoding the custom image and the payment information, and at 471, method 467 may include encrypting the custom image and the payment information. The custom image and the payment information may be encrypted to protect it as it passes over an OS.

At 472, method 467 may include sending the encrypted custom image and the encrypted payment information to a secure server. In some examples, the encrypted custom image may be sent to a first secure server, and the encrypted payment information may be sent to a second, different secure server. The first secure server may be associated with verifying the payment information, while the second secure server may be associated with verifying the custom image, in some examples. As noted above, in some examples, the encrypted custom image and the encrypted payment information may be sent over an operating system. The encryption allows for compliance with PCI DSS.

At 473, method 467 may include decrypting, via the secure server, the encrypted custom image and the encrypted payment information. The decryption may allow for verification of the custom image and the payment information, as they may be compared to known custom images and payment information.

For instance, method 467, at 474 may include comparing the custom image to a database of custom images, and at 475, method 467 may include comparing the payment information to a database of known payment information. A payment authorization application service provider may facilitate the verification of the payment information, and a bank or other authorizing entity may verify the custom image using information in a database of custom images and/or PIN information.

At 476, method 476 may include sending an encrypted payment authentication response to the device. The encrypted payment authentication response may include approved and/or denied responses. Other responses may also be sent. For example, an approved payment authentication response may be sent in response to simultaneously positively verifying the payment information during the comparison to the known information and positively verifying the custom image during the comparison to the database of custom images.

FIG. 5 illustrates a diagram of an example computing system 580 including a processing resource 582, a memory resource 584, and a number of modules 583, 585, 581, 586, 588, 587, 589 according to an example. The computing system 580 may utilize instructions (e.g., software and/or firmware) hardware, and/or logic to perform a number of functions including those described herein. The computing system 580 may be a combination of hardware and program instructions configured to share information. The hardware, for example, may include a processing resource 582 and/or a memory resource 584 (e.g., CRM, MRM, database, etc.).

A processing resource 582, as used herein, may include a processor capable of executing instructions stored by a memory resource 584. Processing resource 582 may be implemented in a single device or distributed across multiple devices. The program instructions (e.g., machine-readable instructions (MRI)) may include instructions stored on the memory resource 584 and executable by the processing resource 582 to implement a desired function (e.g., memory mode categorization).

The memory resource 584 may be in communication with a processing resource 582. A memory resource 584, as used herein, may include memory components capable of storing instructions that may be executed by processing resource 582. Such memory resource 584 may be a non-transitory CRM or MRM. Memory resource 584 may be integrated in a single device or distributed across multiple devices. Further, memory resource 584 may be fully or partially integrated in the same device as processing resource 582 or it may be separate but accessible to that device and processing resource 582. Thus, it is noted that the computing system 580 may be implemented on a participant device, on a server device, on a collection of server devices, and/or a combination of the user device and the server device.

The memory resource 584 may be in communication with the processing resource 582 via a communication link (e.g., a path) 588. The communication link 588 may be local or remote to a machine (e.g., a computing system) associated with the processing resource 582. Examples of a local communication link 588 may include an electronic bus internal to a machine (e.g., a computing system) where the memory resource 584 is one of volatile, non-volatile, fixed, and/or removable storage medium in communication with the processing resource 582 via the electronic bus.

A module and/or modules 583, 585, 581, 586, 588, 587, 589 may include MRI that when executed by the processing resource 582 may perform a number of functions including those described herein. The number of modules 583, 585, 581, 586, 588, 587, 589 may be sub-modules of other modules. For example, the verify module 587 and authentication module 589 may be sub-modules and/or contained within the same computing system. In another example, the number of modules 583, 585, 581, 586, 588, 587, 589 may comprise individual modules at separate and distinct locations (e.g., MRM, etc.).

Each of the number of modules 583, 585, 581, 586, 588, 587, 589 may include instructions that when executed by the processing resource 582 may function as a corresponding engine. For example, the image module 583 may include instructions that when executed by the processing resource 582 may function as an image engine. Similar, each of the number of modules 585, 581, 586, 588, 587, 589 may include instructions that when executed by the processing resource 582 may function as engines.

In some examples, engines may be part of a system (not illustrated) including a database, a subsystem, and the number of engines. The subsystem may include the number of engines in communication with the database via a communication link. The system may represent instructions and/or hardware of a network controller (e.g., system 580 as referenced in FIG. 5, eta).

The number of engines may include a combination of hardware and programming to perform functions including those described herein. The instructions may include instructions (e.g., software, firmware, etc.) stored in a memory resource (e.g., computer readable medium (CRM), machine readable medium (MRM), etc.) as well as hard-wired program (e.g., logic).

In an example, image module 583 may include instructions that when executed by the processing resource 582 may cause a computing system to receive an image of a gesture via a camera coupled to a payment device. In some examples, the gesture may be a PIN spoken in sign language. The gesture, in some examples may be a custom hand gesture created by an owner of the payment information. The gesture may be a generic hand gesture (e.g., thumbs up) in some instances.

Payment module 585 may include instructions that when executed by the processing resource 582 may cause a computing system to receive payment information for a transaction via the payment device. The payment information may come from a user (e.g., the owner of the payment information) using a payment interface on the payment device to use a credit card, debit card, smartphone, or other payment method to pay for the transaction.

Decode module 581 may include instructions that when executed by the processing resource 582 may cause a computing system to decode the image. In some examples, the image may be decoded into data code. Encrypt module 586 may include instructions that when executed by the processing resource 582 may cause a computing system to encrypt the decoded image and the payment information. The encryption may be used to protect the decoded image and the payment information as it is sent to a secure server.

Decrypt module 588 may include instructions that when executed by the processing resource 582 may cause a computing system to decrypt the decoded image and the payment information in response to the decoded image and the payment information passing through an operating system. For example, once through the OS and received by a secure server, the decoded image and the payment information may be decrypted, so that they may be verified.

Verify module 587 may include instructions that when executed by the processing resource 582 may cause a computing system to verify the decrypted decoded image and the decrypted payment information. The decoded image and payment information may be compared to known images and payment information to verify that they belong to the user attempting the transaction. In some examples, the gesture must match with the payment information in order for verification to occur. For example, the instructions may be executable to compare the data code to a database of known data code to verify the decrypted image. The instructions may be executable to compare the payment information to a database of known payment information to verify the payment information.

Authentication module 589 may include instructions that when executed by the processing resource 582 may cause a computing system to authenticate payment for the transaction based on the verified decrypted image and the verified decrypted payment information, If both the image and the payment information are verified, the transaction may be authorized, and an encrypted response stating the same may be sent to the payment device. If one or both of the image and the payment information is not verified a denied response or other response (e.g., “invalid gesture” response) may be sent to the payment device. A response may be communicated to the user via a display on the payment device, in some examples.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature may refer to one or more of such elements and/or features.

What is claimed:

1. A system for payment authentication, comprising:
a payment device comprising:
a camera to collect an image of a gesture; and
a payment interface to collect payment information; and
a computing system coupled to the payment device and comprising:
a processing resource; and
a non-transitory machine-readable medium storing instructions executable by the processor to cause the computing system to:
receive, from the payment device, encrypted payment information and data associated with the gesture;
decrypt the encrypted payment and gesture data;
compare the decrypted payment information and the decrypted gesture data to verified payment and gesture data; and
send an encrypted payment authentication response to the payment device based on the comparison.

2. The system of claim 1, further comprising instructions executable to verify the decrypted payment information and the decrypted gesture data based on the comparison.

3. The system of claim 1, wherein the gesture is a sign language gesture.

4. The system of claim 1, wherein the image is a moving image.

5. The system of claim 1, wherein the image is a still image.

6. The system of claim 1, wherein the payment device is Payment Card Industry Data Security Standard compliant.

7. A machine-readable medium storing instructions executable by a processing resource to cause a computing system to:
receive an image of a gesture via a camera coupled to a payment device;
receive payment information for a transaction via the payment device;
decode the image;
encrypt the decoded image and the payment information;
decrypt the decoded image and the payment information in response to the decoded image and the payment information passing through an operating system;
verify the decrypted image and the decrypted payment information; and
authenticate payment for the transaction based on the verified decrypted image and the verified decrypted payment information.

8. The machine-readable medium of claim 7, wherein the gesture is a personal identification number spoken in sign language.

9. The machine-readable medium of claim 7, wherein the instructions are further executed to decode the image into data code.

10. The machine-readable medium of claim 9, wherein the instructions executable to authenticate payment are further executable to:
compare the data code to a database of known data code to verify the decrypted image; and
compare the payment information to a database of known payment information to verify the payment information.

11. The machine-readable medium of claim 7, wherein the gesture is a custom hand gesture created by an owner of the payment information.

12. A method for payment authentication, comprising:
receiving an image of a custom gesture recorded via a camera coupled to a payment device;
receiving payment information via the payment device;
decoding the custom image and the payment information;
encrypting the custom image and the payment information;
sending the encrypted custom image and the encrypted payment information to a secure server;
decrypting, via the secure server, the encrypted custom image and the encrypted payment information;
comparing the custom image to a database of custom images;
comparing the payment information to a database of known payment information; and
sending an encrypted payment authentication response to the device.

13. The method of claim 12, further comprising sending the encrypted custom image and the encrypted payment information over an operating system.

14. The method of claim 12, further comprising sending the encrypted custom image to a first secure server and sending the encrypted payment information to a second, different secure server.

15. The method of claim 12, further comprising sending an approved payment authentication response in response to simultaneously:
positively verifying the payment information during the comparison to the known information; and
positively verifying the custom image during the comparison to the database of custom images.
